(19) United States
(12) Patent Application Publication
(10) Pub. No.: US 2008/0030100 A1
(43) Pub. Date: Feb. 7, 2008

(54) Vehicle alternator with improved brush device

(75) Inventor: Hiroyuki Ogi, Tajimi-shi (JP)

Correspondence Address: OLIFF & BERRIDGE, PLC, P.O. BOX 320850, ALEXANDRIA, VA, 22320-4850, US

(73) Assignee: DENSO CORPORATION, KARIYA-CITY (JP)

(21) Appl. No.: 11/808,352

(22) Filed: Jun. 8, 2007

(30) Foreign Application Priority Data
Aug. 2, 2006 (JP) 2006-211107

(51) Int. Cl. H01R 39/40

(52) U.S. Cl. 310/245; 310/232

(57) ABSTRACT

A vehicle alternator is disclosed as including a stator having a stator winding, a rotor, having a field winding and rotatably disposed in the stator, which is mounted on a rotary shaft formed with slip rings electrically connected to the field winding, and a brush device including a brush holder having one end formed with an opening portion through which brushes extend toward the slip rings to be held in sliding contact with the slip rings. The brush holder has a discharge port through which foreign matters are expelled. Brush wear particles, resulting from sliding contact between the brushes and the slip rings during operation of the vehicle alternator, pass through clearances between sidewalls of the brush holder and the brushes to the discharge port, through which the brush wear particles are discharged to the outside with no accumulation in the brush holder.

### CROSS REFERENCE TO RELATED APPLICATIONS

This application is related to Japanese Patent Application No. 2006-211107, filed on Aug. 2, 2006, the content of which is hereby incorporated by reference.

### BACKGROUND OF THE INVENTION

1. Technical Field of the Invention

The present invention relates to vehicle alternators and, more particularly, to a vehicle alternator installed on a vehicle such as a passenger car and a truck or the like.

2. Description of the Related Art

In general practice, a vehicle alternator is installed on a vehicle in an engine room thereof and driven with a prime mover to generate electric power for charging a battery of the vehicle. The vehicle alternator also serves to supply electric power for initiating the ignition of the prime mover for illumination on lighting an inside and outside of the vehicle, an in-car audio system and other various electrical components.

In the related art, in order to ensure the vehicle alternator to have a brush life, a brush device has been designed with the account for waterproof of the brush device. In addition, with a view to achieving such an effect, an attempt has heretofore been made to locate the brush device on slip rings in an upper area thereof (see U.S. Pat. No. 6,294,856).

Meanwhile, in recent years, there is an increasing trend for modern motor vehicles to adopt structures such as a device for enhancing the comfort and convenience of passengers and a device installed on an engine or in an engine room to meet legislative regulations typified by exhaust emission controls. Moreover, as an expedient for enhancing a collision safety, the engine room has been designed with a tendency to ensure a certain open space for the purpose of absorbing an impact shock. As a result, various equipments need to be accommodated for placement in the engine room with increased integration degree. An auxiliary device installed on the engine has no exemption.

In particular, the vehicle alternator needs to have a smaller size in structure than that of the other auxiliary device and the vehicle alternator is electrically connected to an engine body through wiring connections in the form of flexible wiring harnesses. Therefore, the vehicle alternator has a higher freedom in layout than that of the other auxiliary device. Accordingly, it has been increasing trends for vehicle manufacturers to determine the layouts of the other auxiliary devices and the associated devices on an initial design while making a design so as to place the vehicle alternator in a surplus open space in the engine room.

Under such technical backgrounds, these days, attempts have heretofore been made to place the brush device in an area beneath the slip rings in increasing tendencies. Even with the brush device arranged in such layout, the brush device has been proposed in a structure to ensure waterproof with the same ordinary level as that of the related art brush device (see, for instance, Japanese Patent Application Publication No. 2006-6000).

Meanwhile, since the brushes of the vehicle alternator are structured in sliding contact with the slip rings for supply of electric power, the brushes gradually wear with the occurrence of wear particles. Therefore, it has been an important task for the brush device of the vehicle alternator to ensure waterproof while reliably expelling the brush wear particles out of the brush device. However, with the brush device of the related art provided with a cover member, the cover member can ensure waterproof even in the presence of the brushes located beneath the slip rings. However, a brush holder of the brush device has a pouched shape with its upper end opened upward. This causes the brush wear particles to accumulate in the brush holder, causing an issue to arise with an increasing probability for the movements of the brushes to be disturbed.

### SUMMARY OF THE INVENTION

The present invention has been completed with a view to addressing the above issues and has an object to provide a vehicle alternator that has increased waterproof and reliability of discharging foreign matters such as brush wear particles out of a brush holder of a brush device.

Hereunder, a detailed structure of the vehicle alternator suited for addressing the above issues will be described below with reference to advantages effects.

To achieve the above object, a first aspect of the present invention provides a vehicle alternator comprising a stator having a stator winding, a rotor, having a field winding and rotatably disposed in the stator, which is mounted on a rotary shaft formed with slip rings electrically connected to the field winding, and a brush device including a brush holder having one end formed with an opening portion and accommodating therein brushes held in sliding contact with the slip rings. The brush holder has a discharge port through which foreign matters are expelled.

With the brush device of the vehicle alternator with such a structure, the brush holder has the discharge port through which the foreign matters are expelled. Therefore, even with the brush device installed under a status with the brushes placed beneath the slip rings, that is, even under a circumstance where the holder opening of the brush holder faces upward to allow the brushes to be forced upward, the foreign matters such as the wear particles, resulting from the wears of the brushes due to the sliding contact between the brushes and the slip rings, are expelled out of the brush holder through the discharge ports in a highly reliable mailer. This prevents the brush wear particles from accumulating in the brush holder, thereby precluding the movements of the brushes from being disturbed.

With the vehicle alternator of the present embodiment, the discharge port may be preferably formed on the brush holder in at least one of a surface opposite to the opening portion of the brush holder and an area close proximity to the surface.

With such a structure, the discharge port is formed on the brush holder in the area in opposition to the opening portion of the brush holder. Thus, under a circumstance where the brush device is installed on the vehicle alternator under a status with the brush being located beneath the slip rings, the brush device can reliably prevent the accumulation of the foreign matters from accumulating in the area in opposition to the opening portion of the brush holder.

With the vehicle alternator of the present embodiment, the discharge port may be preferably formed in a substantially maze pattern.

With such a structure, the discharge port is formed in the substantially maze pattern, no liquid such as water droplets or the like intrude through the discharge port to the inside of the brush holder. In addition, the foreign matters such as the brush wear particles can be expelled through the discharge port out of the brush holder in a highly reliable manner.

With such a structure, the brush device further may preferably include a cover member for covering the slip rings, and a ventilation window passage formed in the cover member between the slip rings and the cover member so as to open to the brush holder as viewed from the slip rings.

With such a structure, under a circumstance where the brush device accommodating therein the brush holder is installed on the vehicle alternator in a status with the brushes being located beneath the slip rings, the ventilation window passage formed between the brush device and the cover member has the opening directed toward the ground. Therefore, no foreign matters such as the water droplets enter the inside of the brush device. Accordingly, the cover member can ensure waterproof, while suppressing an increase in temperature due to frictional heats developed in sliding contact between the brushed and the slip rings. In addition, the provision of the discharge port formed in the brush holder enables foreign matters such as the brush wear particles to be reliably expelled out of the brush holder through the discharge port.

Another aspect of the present invention provides a vehicle alternator comprising a stator having a stator winding, a rotor, having a field winding and rotatably disposed in the stator, which is mounted on a rotary shaft formed with slip rings electrically connected to the field winding, and a brush device including a brush holder having one end formed with an opening portion and accommodating therein brushes held in sliding contact with the slip rings, wherein the brush holder has a bottom portion formed with a discharge port through which foreign matters are expelled.

With the brush device of the vehicle alternator with such a structure, the brush device includes the brush holder having one end formed with the opening portion and accommodating therein brushes held in sliding contact with the slip rings. In addition, the brush holder has the discharge port through which the foreign matters are expelled. Accordingly, even if the brush device is located in a layout with the brushes placed beneath the slip rings, that is, even when the holder opening of the brush holder faces upward to allow the brushes to be forced upward, the foreign matters such as the wear particles, resulting from the wears of the brushes due to the sliding contact between the brushes and the slip rings, are expelled out of the brush holder through the discharge ports in a highly reliable manner. This prevents the accumulation of the brush wear particles in the brush holder, thereby precluding the movements of the brushes from being disturbed.

A further aspect of the present invention provides a vehicle alternator comprising a stator having a stator winding, a rotor, having a field winding and rotatably disposed in the stator, which is mounted on a rotary shaft formed with slip rings electrically connected to the field winding, and a brush device including a brush holder having one end formed with an opening portion and accommodating therein brushes held in sliding contact with the slip rings. The brush holder has sidewalls having upper ends, formed with a holder opening through which the brushes extend toward the slip rings in sliding contact therewith, and a bottom portion integrally formed with the sidewalls and having discharge ports through which foreign matters are expelled.

With the brush device of the vehicle alternator with such a structure, the brush device includes sidewalls having upper ends, formed with a holder opening through which the brushes extend toward the slip rings in sliding contact therewith, and a bottom portion integrally formed with the sidewalls and having discharge ports through which foreign matters are expelled. Therefore, even under a situation where the brush device is located in a layout with the brushes placed beneath the slip rings, that is, even under a circumstance where the holder opening of the brush holder faces upward to allow the brushes to be forced upward, the foreign matters such as the wear particles, resulting from the wears of the brushes due to the sliding contact between the brushes and the slip rings, are expelled out of the brush holder through the discharge ports in a highly reliable manner. This prevents the accumulation of the brush wear particles in the brush holder, thereby precluding the movements of the brushes from being disturbed.

### BRIEF DESCRIPTION OF THE DRAWINGS

FIG. 1 is a cross sectional view showing an overall structure of a vehicle alternator of an embodiment according to the present invention.

FIG. 2 is an enlarged fragmentary view showing a brush device incorporated in the vehicle alternator shown in FIG. 1.

FIG. 3 is an enlarged fragmentary view showing a brush device of a first Comparison Example of the related art.

FIG. 4 is an enlarged fragmentary view showing a brush device of a second Comparison Example of the related art.

### DETAILED DESCRIPTION OF PREFERRED EMBODIMENTS

Now, a vehicle alternator of an embodiment according to the present invention will be described below in detail with reference to the accompanying drawings. However, the present invention is construed not to be limited to such an embodiment described below and technical concepts of the present invention may be implemented in combination with other known technologies or the other technology having functions equivalent to such known technologies.

A vehicle alternator of an embodiment according to the present invention will be described below in detail with reference to the accompanying drawings.

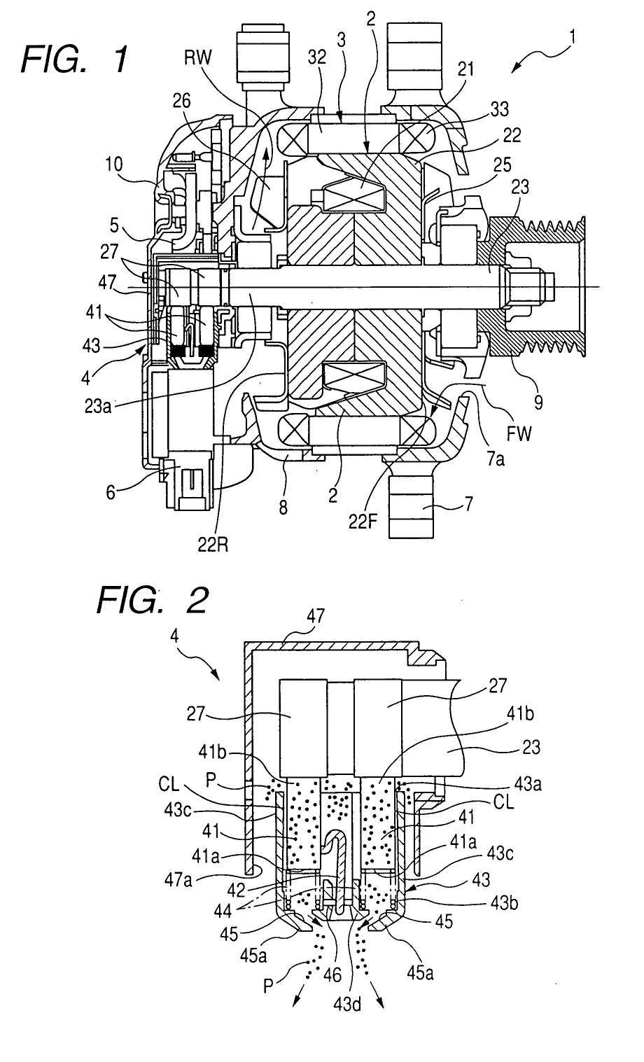

FIG. 1 is a longitudinal cross sectional view showing the vehicle alternator (hereinafter merely referred to an “alternator”) of the present embodiment implementing the present invention.

As shown in FIG. 1, the alternator 1 is an alternator of the type having a cooling fan. The alternator 1 includes a rotor (rotator) 2, a stator (stationary part) 3, a brush device 4, a commutator device 5, an IC regulator 6, a drive frame 7, a rear frame 8, a pulley 9, and a rear cover 10, etc.

The rotor 2 takes the form of a structure that includes a pair of front and rear pole cores 22 carried on a shaft 23 in a face-to-face relationship so as to sandwich a field winding 22 composed of a copper wire would in a cylindrical and concentric shape therebetween. Each pole core 22 has six claw portions that are formed at circumferentially and equidistanly spaced positions. In addition, the front pole core 22 has a front end face 22F carrying thereon a front cooling fan 25 fixedly secured to the front pole core 22 by welding or the like for drawing cooling wind streams FW through a plurality of air-intake windows 7a formed on the drive frame 7 to blow out the cooling wind streams FW in axial and radial directions. Likewise, the rear pole core 22 has a rear end face 22R carrying thereon a rear cooling fan 26 fixedly secured to the rear pole core 22 by welding or the like for drawing cooling wind streams RW through a plurality of ventilation windows (not shown) formed on the rear frame 8 to blow out the cooling wind streams RW in axial and radial directions.

In addition, the shaft 23 has a rear end portion 23a carrying thereon two collector rings (slip rings) 27 at axially spaced positions. The slip rings 27 are electrically connected to both ends of the field coil 21 to supply electric power from the brush device 4 to the field winding 21. The stator 3 includes a stator core 32, sandwiched between the drive frame 7 and the rear frame 8 for support in a fixed place, and a three-phase stator winding 33 or the like.

The brush device 4 plays a role as a device to allow excitation current to flow from the commutator device 5 to the field winding 21 of the rotor 2. The brush device 4 includes two brushes 41 held in pressured contact with the two slip rings 27 provided on the rear end portion 23a of the shaft 23 of the rotor 2. When assembling the vehicle alternator 1 of the present embodiment onto a vehicle, the brush device 4 is placed on a mounting position set such that the brushes 41 are located beneath the slip rings 27 so as radially extend downward and pressed in radially upward directions.

The commutator device 5 serves to rectify a three-phase alternating voltage, that is, an output voltage of the three-phase stator winding 33, to obtain a D.C. output power. The rear cover 10 serves to cover electric component parts such as the brush device 4, the commutator device 5 and the IC regulator 6 or the like mounted on an outside face of the rear frame 8 to protect these component parts. The rear cover 10 is fixedly secured to the outside face of the rear frame 8 by tightening bolts, extending therefrom, with metal nuts with the commutator device 5 being sandwiched.

The drive frame 7 and the rear frame 8 accommodate therein the rotor 2 and the stator 3 to allow the rotor 2 to rotate about the rotary shaft 23, and the stator 3 is fixedly secured so as to have a given clearance with respect to an outer periphery of the pole core 22 of the rotor 2.

Further, the drive frame 7 and the rear frame 8 have, in addition to front and rear end walls provided with the air-intake windows, front and rear outer circumferential portions formed with discharge windows in areas radially aligned with front and rear axial extensions of the stator windings 33 axially protruding from axial end faces of the stator core 32. Thus, the front and rear cooling winds are caused to be brown out of the alternator 1 through the discharge windows.

Next, reference is made to FIG. 2 to describe a detailed structure of the brush device 4. FIG. 2 is an enlarged cross sectional view showing the brush device 4 in association with the rotary shaft 23 carrying thereon the slip rings 27.

As shown in FIG. 2, the brush device 4 includes the brushes 41 having a power supply wire 42, a brush holder 43 accommodating therein the brushes 41, and springs 44 serving as resilient members for pressing the brushes 41 against the slip rings 27 to cause base ends 41b to be held in sliding contact with the slip rings 27 provided on the rotary shaft 23 at the rear end thereof.

The brush holder 43 includes a substantially box-like case, made of synthetic resin, which has a base end portion, whose front and rear sidewalls have opening portions 43a formed in areas facing the slip rings 27. The brush holder 43 has a bottom portion 43b placed in opposition to the opening portions 43a, which have discharge ports 45 extending in slant directions to discharge foreign particles P to the outside the brush holder 43.

The springs 44 are disposed in spaces between the bottom portion 43b of the brush holder 43 and end portions 41a of the brushes 41 at base ends thereof under preliminarily compressed conditions to generate given loads. Further, an appropriate amount of clearance CL is provided between each of sidewalls 43c of the brush holder 43 and an outer periphery of each brush 41 to enable each brush 41 to smoothly move. The brush holder 43 has a wire holder portion 43d formed in an area near the bottom portion 43b of the brush holder 43 and has a metal fitting 46 to which the power supply wire 42 is electrically and mechanically connected by a suitable method such as soldering.

Further, the brush device 4 has a slip ring cover 47 serving as a cover member for surrounding the slip rings 27. The slip ring cover 47 is used with the brush holder 43 in combination therewith to have a function defining a ventilation window passage 47a between an inner wall of a lower end portion of the slip ring cover 47 and the adjacent sidewall 43c of the brush holder 43. In addition, liquid droplets such as water droplets or the like are kept away from the slip rings 27 and the brushes 41 and liquid droplets are prevented from intruding the opening portion 43a of the brush holder 43. In addition, the ventilation window passage 47a, defined between the slip rings 27 and the collector0ring cover 47, is opened toward the brush holder 43 as viewed from side areas of the slip rings 27.

The brush device 4, formed in such a structure, is suitably placed such that the brushes 41 are placed beneath the slip rings 27 with the most typical exemplified structure being shown in FIG. 2 with the brushes 41 placed directly beneath the slip rings 27.

Next, the operation of the brush device 4 of the alternator 1 is described below.

In operation, upon receipt of a drive power from a prime mover, the rotor 2 is caused to rotate with the accompanied rotations of the slip rings 27. Meanwhile, since the brush device 4 is fixedly supported on the rear frame 8 to be non-rotatable, no rotations of the brushes 41 occur. The brushes 41 is supplied with electric power from an external source via the electric power supply wire 42 and pressed toward the slip rings 27 by means of the springs 44. Under such a state, the brushes 41 are held in sliding contact with the slip rings 27 to apply electric power to the field coil 21 through the slip rings 27.

In general, the brushes 41 are made of material such as graphite and the slip rings 27 are made of material such as copper. With sliding operations of the both of these members, the brushes 41 gradually wear, generating wear particles P. The wear particles P pass through a clearance between the brushes 41 and the sidewalls 43c of the brush holder 43 and are directed downward due to actions of gravity. The wear particles P pass through the brush holder 43 to the bottom portion 43b thereof, upon which the wear particles P are expelled from the discharge ports 45.

Thus, no wear particles P accumulate on the bottom portion 43b. In addition, the discharge ports 45 are formed with slants 45a, respectively, in the form of substantially maze patterns. This prevents foreign matters such as water droplets or other liquid droplets from entering an inside of the brush holder 43 from the outside.

Here, first and second Comparison Examples of the related art, wherein brush devices with related art structures are placed beneath the slip rings, are described below for comparison to the brush device of the present embodiment.

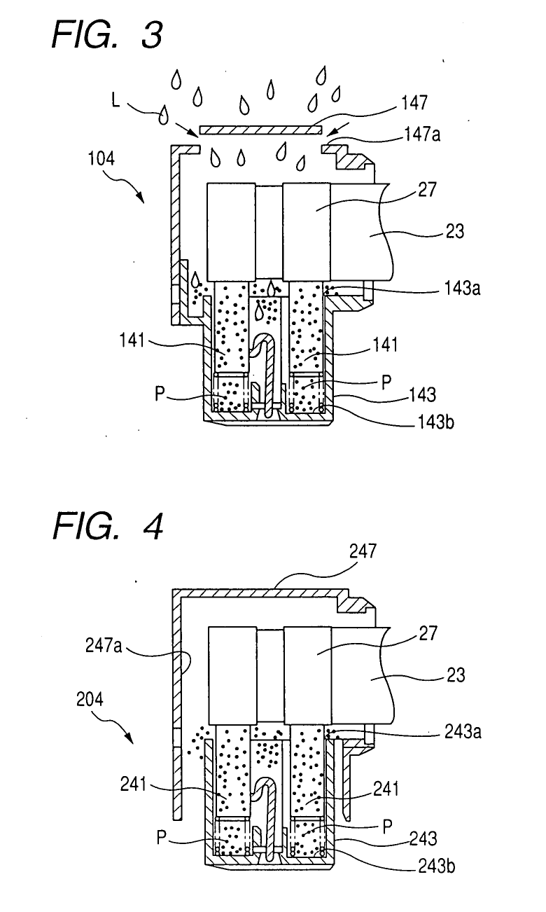

Of the brush devise of the related art structures, the first Comparison Example is of the type in which brushes are placed on slip rings so as to extend upright in nature. FIG. 3 shows the brush devise 104 of the first Comparison Example.

With the brush devise 104 used in a status with brushes 141 placed beneath the slip rings 27, liquid such as water droplets L easily intrude an inside of a brush holder 147 from ventilation passages 147a of a slip ring cover 147. This causes corrosions to occur on internal component parts such as the slip rings 27.

With the progress of corrosions occurring on the slip rings 27, degradation occurs in a proper sliding contact between the brushes 141 and the slip rings 27, inducing remarkable wears of the brushes 141. When this takes place, the brushes 141 and the slip rings 27 produce wear particles P. The wear particles P drop through a holder opening 143a of the brush holder 143 into spaces between bottom walls of the brushes 141 and a bottom wall 143b of the brush holder 143 and accumulate therein. Thus, an issue arises with the occurrence of disturbances in smooth movements of the brushes 141.

Of the brush devise of the related art structures, the second Comparison Example is of the type in which brushes are placed on slip rings so as to extend downward in nature. FIG. 4 that shows the brush devise 204 of the second Comparison Example.

With the brush devise 204 of the second Comparison Example, even if brushes 241 are placed beneath the slip rings 27, no liquid such as water droplets intrude into an inside of a brush holder 243 because a slip ring cover 247 has a ventilation opening directed downward in communication with the outside.

During the flow of ventilation air streams through the ventilation passage 147a, wear particles P partly pass through the ventilation passage 247a to the outside. However, a major part of the wear particles P drop through a holder opening 243a of the brush holder 243 into spaces between bottom walls of the brushes 241 and a bottom wall 243b of the brush holder 243 and accumulate therein. This results in the occurrence of disturbances in smooth movements of the brushes 141.

As will be apparent from the foregoing description, with the brush device of the present embodiment, the brush holder 43 includes the discharge ports 45 for expelling the foreign materials such as wear particles P. Thus, even with the brush device 4 located in a state with the brushes 41 placed beneath the slip rings 27, that is, even under a circumstance where a holder opening 43a faces upward to allow the brushes 41 to be forced upward, the foreign matters such as the wear particles P, resulting from the wears of the brushes 41 due to the sliding contact between the brushes 41 and the slip rings 27, are expelled through the discharge ports 45 in a highly reliable manner.

This prevents the accumulation of the brush wear particles in the brush holder 43, thereby precluding the disturbances from occurring in movements of the brushes 41. Specifically, the discharge ports 45 are formed on the bottom portion 43b in areas in opposition to the holder opening 43a of the brush holder 43, thereby reliably preventing the foreign matters such as the brush wear particles from accumulating in the bottom portion 43b.

Further, the discharge ports 45 are formed with the slants 45a, respectively, in the form of the maze patterns, thereby preventing liquid such as the water droplets or the like from entering the inside of the brush holder 43 from the outside while making it possible to expel the foreign matters such as the brush wear particles P of the outside in a highly reliable manner.

Furthermore, the brush device 4 of the present embodiment additionally includes the slip ring cover 47 for covering the slip rings 27. The slip ring cover 47 has the ventilation window passage 47a, formed between the slip rings 27 and the slip ring cover 47, which is opened in face with the brush holder 43 as viewed from the slip rings 27. Thus, with the brush device 24 installed to allow the brushes 41 in the areas beneath the slip rings 27, the ventilation window passage 47a is directed toward the ground. This prevents the foreign matters such as the water droplets or the like from entering the inside of the brush device 4.

Thus, the brush device 4 of the present embodiment suppresses an increase in temperature due to frictional heats developed with the brushes 41 and the slip rings 27 in sliding contact with each other while ensuring the slip ring cover 47 to have increased waterproof. In addition the provision of the discharge ports 45 formed in the brush holder 43 at the bottom portion 43b thereof makes it possible to reliably expel the foreign matters such as the brush wear particles.

While the specific embodiment of the present invention has been described in detail, it will be appreciated by those skilled in the art that various modifications and alternatives to those details could be developed in light of the overall teachings of the disclosure.

While the present invention has been exemplarily described in detail with reference to the specific embodiment with the brush holder 43 having the discharge ports 45 formed on the bottom portion 43b, the discharge ports 45 may be formed in other areas of the brush holder 43 in opposition to the holder opening 43a thereof or in areas close proximity to such other areas because such areas enable the brush wear particles or the like to be reliably expelled. For instance, the discharge ports 45 may be formed on the sidewalls 43c of the brush holder 43.

Thus, the particular arrangement disclosed is meant to be illustrative only and not limited to the scope of the present invention, which is to be given the full breadth of the following claims and all equivalents thereof.

What is claimed is:

1. A vehicle alternator comprising:
a stator having a stator winding;
a rotor, having a field winding and rotatably disposed in the stator, which is mounted on a rotary shaft formed with slip rings electrically connected to the field winding; and
a brush device including a brush holder having one end formed with an opening portion and accommodating therein brushes held in sliding contact with the slip rings;
wherein the brush holder has a discharge port through which foreign matters are expelled.

2. The vehicle alternator according to claim 1, wherein:
the discharge port is formed on the brush holder in at least one of a surface opposite to the opening portion of the brush holder and an area close proximity to the surface.

3. The vehicle alternator according to claim 1, wherein:
the discharge port is formed in a substantially maze pattern.

4. The vehicle alternator according to claim 1, wherein:
the brush device further includes a cover member for covering the slip rings, and a ventilation window passage formed in the cover member between the slip rings and the cover member so as to open to the brush holder as viewed from the slip rings.

5. A vehicle alternator comprising:
a stator having a stator winding;
a rotor, having a field winding and rotatably disposed in the stator, which is mounted on a rotary shaft formed with slip rings electrically connected to the field winding; and
a brush device including a brush holder having one end formed with an opening portion and accommodating therein brushes held in sliding contact with the slip rings;
wherein the brush holder has a bottom portion formed with a discharge port through which foreign matters are expelled.

6. The vehicle alternator according to claim 5, wherein:
the discharge port is formed in a substantially maze pattern.

7. The vehicle alternator according to claim 5, wherein:
the brush device further includes a cover member for covering the slip rings, and a ventilation window passage formed in the cover member between the slip rings and the cover member so as to open to the brush holder as viewed from the slip rings.

8. A vehicle alternator comprising:
a stator having a stator winding;
a rotor, having a field winding and rotatably disposed in the stator, which is mounted on a rotary shaft formed with slip rings electrically connected to the field winding; and
a brush device including a brush holder having one end formed with an opening portion and accommodating therein brushes held in sliding contact with the slip rings;
wherein the brush holder has sidewalls having upper ends, formed with a holder opening through which the brushes extend toward the slip rings in sliding contact therewith, and a bottom portion integrally formed with the sidewalls and having discharge ports through which foreign matters are expelled.

9. The vehicle alternator according to claim 8, wherein:
the discharge ports are formed in substantially maze patterns.

10. The vehicle alternator according to claim 8, wherein:
the brush device further includes a cover member for covering the slip rings, and a ventilation window passage formed in the cover member between the slip rings and the cover member so as to open to the brush holder as viewed from the slip rings.
